(19) United States
(12) Patent Application Publication
(10) Pub. No.: US 2003/0225584 A1
(43) Pub. Date: Dec. 4, 2003

(54) System and method for providing joy or amusement

(75) Inventor: Jay M. Kraker, Houston, TX (US)

Correspondence Address: LOCKE LIDDELL & SAPP LLP, 600 TRAVIS, 3400 CHASE TOWER, HOUSTON, TX, 77002-3095, US

(73) Assignee: KRAKER & COMPANY, INC.

(21) Appl. No.: 10/157,587

(22) Filed: May 29, 2002

(51) Int. Cl. G06F 17/60

(52) U.S. Cl. 705/1

(57) ABSTRACT

A system and method of providing joy or amusement by providing at least one card wherein the card contains an instruction that is hidden at the time of receipt. Upon revealing the instruction, the recipient receives joy or amusement and may undertake the instruction. In a preferred embodiment, this provision includes charitable donations.

### FIELD OF THE INVENTION

This invention relates to the provision of amusement and activities, including the provision of instructions using tangible mediums or via a wide area network such as the Internet.

### BACKGROUND OF THE INVENTION

A diverse group of psychologists, therapists, spiritual advisers and management consultants all have recommended solutions to increase personal fulfillment and productivity by striking a balance between work and play, or work and renewal.

McGee-Cooper cited eight benefits of “integrating a variety of short, brain-balancing breaks into each work day.” She explained that people “usually hit a productivity peak at a certain point each day (or over a span of a certain number of hours worked), then their efficiency, carefulness, motivation and creativity steadily wane.” McGee-Cooper, Ann; Trammell, Duane; and Lau, Barbara. You Don't Have to Go Home from Work Exhausted! The Energy Engineering Approach. Dallas, Tex.: Bowen & Rogers, 1990, p. 67. While exhorting readers to develop their own, personal “fun inventory” to re-energize themselves at these times, McGee-Cooper found a fundamental flaw in early versions of her own list: “I discovered that I knew of very few ways to have fun that required less than 30 minutes. Yet most of my free time open for fun was only small bits of time” (author's emphasis). Ibid, p. 77. Indeed, so few individuals have made time to read 350-page books on time management and energy engineering, that the author has built a successful practice transforming her own advice into bite-size nuggets delivered in seminars and workshops for busy managers and executives.

Colantuono guided readers to experience joy in their lives by practicing forgiveness, taking time-outs, being appreciative, and enjoying simple extravagances and healthy indulgences, among other things. Still, she was compelled to regularly accompany even common-sense advice with distinct sections entitled, “Yes, but . . . ” in anticipation of resistance from readers who are too busy, overwhelmed with responsibilities, tied to their own past habits, and concerned about what others will think of them if they follow these admonitions. Colantuono, Susan. Make Room for Joy. Providence, R.I.: Interlude Productions, 2000, p. 40.

Last among his Seven Habits of Highly Effective People, Covey lists “sharpening the saw,” a phrase that denotes inherently personal activities in four dimensions of life—physical, mental, spiritual and social/emotional—that are essential but rarely urgent until crisis strikes. Taking care of oneself in all four of these respects, according to Covey, is “the habit that makes all the others possible.” Covey, Stephen R. The Seven Habits of Highly Effective People. Simon & Schuster, Fireside Edition, 1990. p. 287. “This is the single most powerful investment we can ever make in life—investment in ourselves, in the only instrument we have with which to deal with life and to contribute.” Ibid, p. 289.

Therefore, a need exists to provide a system and method of amusement and activities that help alleviate the imbalance between work and play, to relax or do something that is different, or to encourage individuals to invest in their own productive capacity. The present invention provides such a system and method.

### SUMMARY OF THE INVENTION

The present invention is a noncompetitive game designed to increase the amount of joy, amusement, or similar feelings that individuals experience everyday. In a preferred embodiment, the invention includes a noncompetitive game or experience in which players receive cards that provide game instructions selected randomly from a database. Each instruction details one way that individuals can experience amusement, joy, or other positive feelings. In a preferred embodiment, these devices may take the form of instruction cards, scratch-off game pieces, or tickets, similar to those used by state lotteries in the United States and in countries other than the United States.

The present invention game may be played by obtaining either a printed card or one that is displayed on a computer monitor. On both types of cards, the instruction remains hidden until a player scratches off the panel that covers it or otherwise reveals the hidden instruction. In the case of the computer-generated card, the instruction is revealed when a player uses a computer mouse or similar device to “scratch off” the hidden panel displayed on the monitor or otherwise reveal the hidden instruction.

Instructions for the present invention are compiled in a database that allows game cards to be printed or produced electronically in random fashion so that players are highly unlikely to guess in advance the contents of any one card. This random printing also makes it so that collections of printed cards are likely to have a broad variety of individual instructions.

The instruction on each card of the present invention may be categorized in the database in one or more of the following ways: 1) time required to complete the activity, 2) activities likely to appeal to individuals with various demographic characteristics, including but not limited to: age, sex, city of residence, role in family, role in employment, and/or other personal, situational considerations. Those skilled in the art will recognize that these criteria represent but a few of the possible categories that may be included while providing the intended spirit of the invention. Accordingly, the inclusion of additional categories to provide a broad variety of individual instructions is considered to be within the scope of the invention. This categorization of individual present invention instructions permits a player to select an amusement or joy instruction that belongs to one or more of these classifications, and to receive an instruction at random from within the chosen subset(s) of the present invention.

The present invention addresses the problems that can occur when people do not make time—or remember how—to experience amusement or joy. In procuring a card, an individual gives himself or herself “permission” to enjoy themselves for a period of time, and the card serves as a tangible reminder to do so. Similarly, the present invention card provides explicit instruction to undertake a particular activity that can produce joy for that individual and others who become part of the activity. Cards may be given by one person to another as an expression of friendship, love, or compassion. Again, the card constitutes both permission and instructions for the recipient to experience joy.

### BRIEF DESCRIPTION OF THE DRAWINGS

FIG. 1 is a representative instruction card with the instruction hidden; and

FIG. 2 is a representative instruction card with a representative instruction shown.

Those skilled in the art will recognize that the figures shown here represent just one method of providing the intended spirit of the invention. Accordingly, instruction cards containing significant deviations from the figures are considered to be within the scope of the invention, and nothing herein shall be considered to limit the scope of the invention as dependent in the claims.

### DETAILED DESCRIPTION OF PREFERRED EMBODIMENT

Those skilled in the art will recognize that the following detailed description of the preferred embodiment represents examples of the system and method of providing joy and amusement via at least one hidden instruction that may cause the recipient to follow the instruction and provide joy to the recipient or to a third party.

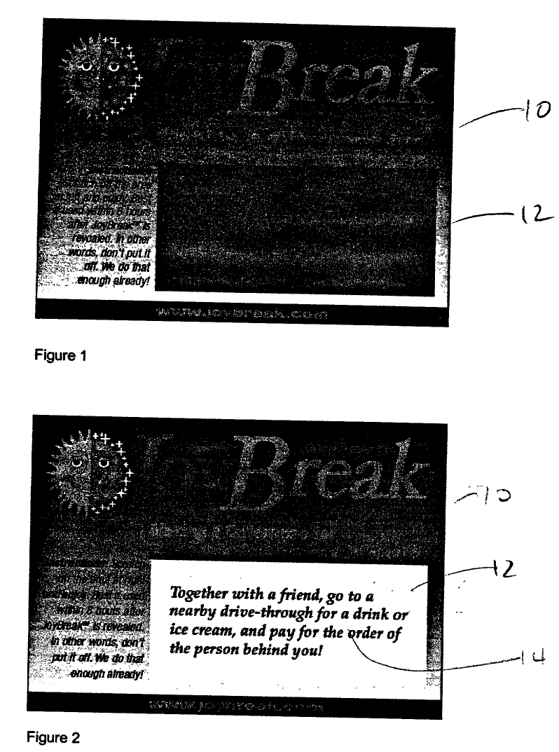

FIG. 1 is a representative instruction card 10 with a hidden instruction. As an overview, an embodiment of the invention provides for cards, also called game pieces or tickets, which may be printed commercially or developed as image files to appear on a computer monitor to resemble a printed card. Dimensions of the printed card are not fixed, although some cards measure 3.5 by 2.5 inches. Cards generally are of such a size that they may be held in one hand easily and fit into a pocket or purse. The term “card” is used broadly to include any medium in which a hidden instruction can be fixed physically, electronically, magnetically, optically, or other sensory-accessible medium and later revealed.

Each card 10 incorporates a panel 12 that at least partially covers or hides an instruction until such time that the user chooses to expose the instruction. This covering may be a coating applied after the printing process or, in the case of a computerized card, a colored panel can serve as a “coating.” In both cases, the panel prevents the instruction from becoming exposed accidentally. In at least one embodiment, the instruction is written on a front surface, so that after removal of the coating or other method of hiding the instruction, the instruction is visible.

FIG. 2 shows a card with the panel 12 after it has been “scratched off.” To play the game, a participant obtains a card 10, either through a purchase or its receipt as a gift, then scratches off the panel 12 to reveal an exemplary instruction 14 to engage in a specific activity. To complete the game, the player follows the instruction. It is recommended that this occur within eight (8) hours, or as soon as possible after the instruction is revealed.

The present invention game increases amusement and joy in life of the user by effectively granting permission for a person to enjoy himself or herself, and simultaneously provides a single, precise instruction suggesting a way to do so. This eliminates the need for individuals to engage in a more time-consuming search for—or consideration of—a broad range of possible activities. Moreover, the present invention enables users to select instructions customized to match their interests, time constraints and personal situations.

Those skilled in the art will recognize that the spirit of the scope of the invention as described above may be applied to virtually any activity capable of providing amusement or joy. The following examples are representative, and not limiting, of the embodiments that are considered to be within the scope of the invention.

In the context of greeting cards, it is envisioned that the present invention would provide both the purchaser and recipient with the ability to provide and receive, respectively, enjoyment. In this embodiment, the purchaser may choose among available categories based on factors including demographics, time, and similar categories, including but not limited to the ones discussed previously herein. The actual content of the instruction remains secret until the recipient reveals the instruction panel using the process similar to the ones described in FIG. 1 and FIG. 2. This adds to the element of surprise in each instruction card of the present invention. Effectively, the purchaser has the ability to provide amusement and joy for the recipient, but also receives reciprocal amusement and joy from eventually learning of the contents of the card that the purchaser provided.

Notably, the purchaser may also procure an instruction card for him or herself, and enjoy the full surprise value of the instruction card. Though many embodiments will be available, it is intended that the present invention offers an interactive experience capable of providing the opportunity for amusement and joy in the recipient. Notably, the revealing of the instruction does not complete the process. The completion of the instruction activity contained within the instruction card will provide a sense of completion and fulfillment. It is envisioned that the recipient may share the instruction with others and may be repeated by the purchaser or third parties.

It is envisioned that the present invention will encourage specific, detailed, and/or random acts of kindness and thoughtfulness. It is possible that these acts will provide for philanthropy among parties. It is also envisioned that these instruction cards may be traded amongst participants in order to allow multiple users to enjoy the activity and therefore provide goodwill to multiple parties. In at least one embodiment, these instruction cards will also enable the buyers and/or the recipients to specify donations to charities in their name, or the name of another party.

Another embodiment may include the provision of this opportunity to experience joy beyond the revealing of the activity in the form of the fortune cookie market. Notably, existing fortune cookies presently only offer a witty snippet or proverbial wisdom that ends with the reading of the fortune. Existing messages in fortune cookies do not provide for a following instruction to be completed. Therefore the present invention would offer within the fortune cookie an instruction or similar message that could be completed by the recipient of the fortune cookie. As with the previous embodiments, this instruction could be forwarded, copied or otherwise duplicated to third parties for additional use.

The present invention may also be incorporated with various fund-raising methodologies. There are at least three embodiments advantageously providing the present invention for charitable purposes. In a first embodiment, multiple charities can receive a portion of the proceeds from designated game card sales without offering cards—printed or electronic or both—for sale directly. In this approach, cards are sold, such as through a website that supports the charities. In a second embodiment, a charity offers game cards for sale directly, such as with electronic cards offered on its own website. In a third embodiment, which can be incorporated with either of the first two, individual game card instructions can include requests for a charitable contribution, such as cash or other valuable items. In this embodiment, the proceeds that a charity can generate through appeals from contributions is considerably larger and more direct.

In a preferred method, the cards can be sold individually or by subscription. A portion of the proceeds from the game card sales can be donated to charity. As an example, the percentage can range from about ten percent (10%) to sixty-seven percent (67%) as outlined below.

As an example of the first embodiment for charitable fund raising, game cards can be sold through the websites of a central location or other types of outlets related to an entity. When game cards are purchased, the purchaser is given the opportunity to select a charity from a list. The designated charity receives a percentage of the price of that purchase. Corporate donations of a percentage of designated customer purchases to charities are considered to be within the scope of the invention. By example, the American Express Membership Rewards® program allows members to designate donations to charities based on a percentage of their designated purchases. These programs may include a minimum purchase requirement to generate the initial donation. This program provides an opportunity to designate the charity that will receive donations in these manners.

Similarly, the instruction card may be incorporated with seasonal or one-time philanthropy drives associated with corporate or banking institutions or other entities. When the preferred method for sales of the game tickets to the present invention is employed, donations to nonprofit organizations become a fundamental element of the present invention.

Using this method, charities could receive a percentage, preferably a minimum ten percent (10%), of the present invention's ticket sales. In a preferred embodiment, more than half of the purchase price of the present invention could be donated to charities. It is also envisioned that the present invention could focus on the number of charities participating within the program such that the game participants would be able to choose categories rather than specific charity programs.

It is envisioned that the preferred method incorporates a graduated scale for the percentage of sales donated to charities, where the scale increases with the effort of the charity. As one example, Table I shows two options among others that could be used depending on the effort of the charity.

TABLE 1

| Charity Activities | Revenue % |
|---|---|
| None | 10% |
| Promotion only | 25% |

In this embodiment, the charitable donation could range from a minimum of about 10% of the sales with no charity participation whatsoever to 25% for some level of participation such as promoting the card purchases or other aspects in conjunction with the seller of the cards.

As an example of the second embodiment for charitable fund raising, a charity could increase its participation and sell the cards directly to increase the percentage of funds given to the charity. Game cards can be sold through the websites of “sponsoring charities” as illustrated by example below.

Sponsoring charities are those nonprofit organizations that promote the present invention and offer game cards for sale directly, either through their own websites, in print, or through other available outlets related to the sponsoring charity. Sponsoring charities receive some or all game card proceeds and are assessed fees, expressed as a percentage of sales, for use of the game. As an example, net revenue to sponsoring charities can be a minimum of about fifty-one (51) percent, although other percentages can apply.

The preferred method increases the portion of revenue that a charity receives as it increases promotion activities and actual sales of the game cards, such as follows:

TABLE 2

| Annual direct sales exceeding | |
|---|---|
| $0 | 51% |
| $50,000 | 55% |
| $100,000 | 59% |
| $250,000 | 63% |
| $500,000 | 67% |

Sponsors could have an opportunity to increase their portion of the sales by exceeding a series of revenue goals.

As an example of the third embodiment of charitable fund raising, cards can be sold or otherwise offered that have an instruction for donating to a charity something of value. This donation can give satisfaction and fulfillment and therefore can cause enjoyment in helping worthwhile causes. The majority of fund-raising solicitations offer no direct benefit to the prospective donor beyond the possibility of receiving a tax deduction that reduces the net cost of the gift. Through this invitation and instruction of the present invention, participants are able to have further amusement and enjoyment by participating in this specific surprise activity that offers another direct and immediate benefit to the purchasers.

To increase the efficiency of fund-raising operations, the majority of solicitations for contributions to organizations are targeted to people believed to be willing and able to donate a specific amount of money, or people willing to solicit donations from others. Many of these nonprofit donors are provided with a choice of contribution amounts listing figures in descending order and typically ranging from about $100 or more to a minimum suggested contribution of $25 or $50.

This approach to fund-raising fails to reach a broad audience that is willing to donate, but only in smaller amounts. The present invention offers instruction cards that are sold at a nominal price, such as $1 apiece, with no minimum for printed tickets and a minimum of $5 for five game pieces for Internet sales. The present invention increases the ability of nonprofit organizations to obtain contributions from smaller donors. This distinction also makes it possible to encourage philanthropy among younger people compared to those typically considered to be best candidates for larger donations. The cumulative response from the present invention is envisioned that it can exceed the discrete larger donations currently solicited.

With the exception of nonprofit agency websites that encourage donations at any time, nonprofit organizations typically offer for sale specific merchandise that is either seasonal in nature or offered for a very limited time, such as once per year. The vast majority of charitable find-raising techniques are designed to generate contributions on the charity schedule, rather than when the donor is necessarily able and ready to give. By definition, such fund-raising activities do not work to keep the name and mission of the nonprofit organization in the public eye for more than a few weeks per year. The present invention offers a year-round continuous promotion, such that the provision of revenues will exist beyond the cyclical and periodic attempts of charitable organizations.

When nonprofit agencies offer any type of merchandise in return for a cash contribution, it is a one-time exchange. In contrast, the present invention offers the ability for the charity to sell cards as ticket subscriptions or other formats through its own website, enabling the present invention to deliver a benefit to donors for a period of time following their initial purchase. In addition, it is envisioned that the present invention will increase the charity name's recognition among donors and potential donors, without the expenses associated with the typical methods of seeking contributions.

When nonprofit agencies offer any merchandise in return for a cash contribution, the value of the contribution as a tax deduction to the donor is reduced by the value of the merchandise provided. In contrast, the present invention enables the organization to offer a benefit without reducing the value of the donor's purchase as a tax deduction. It is noted that the full value of the purchase may be recognized as a tax deduction because the present invention's game pieces that are provided to the donor have no intrinsic value.

Although the present invention has been described with reference to the preferred embodiments, those skilled in the art will recognize that modifications and changes may be made in the form of detail without departing from the scope and spirit of the invention. The foregoing disclosure and description of the invention are illustrative and exemplary thereof. Various changes in configurations, substitution, expansion, modification, rearrangement, omission, deletion, or similar activity are considered to be within the scope of the invention. Having described the invention above, it is intended that all variations within the scope and spirit of the claims should be embraced thereby.

What is claimed is:

1. A method of collecting donations, comprising the steps of:
(a) providing a card to a purchaser, wherein the card comprises at least one instruction that is at least partially hidden;
(b) allowing the purchaser to send the card to a recipient;
(c) allowing the recipient to reveal the instruction; and
(d) receiving a donation from the purchaser, recipient, or a combination thereof.

2. The method of claim 1, wherein the instruction comprises a request for a donation.

3. The method of claim 1, wherein allowing the recipient to reveal the instruction comprises providing a removable coating applied to the card and covering at least a portion of the instruction.

4. The method of claim 1, wherein receiving the donation comprises receiving an amount of the donation according to a graduated scale of participation.

5. The method of claim 1, wherein the card comprises an electronic representation provided over a wide area network.

6. A system for providing non-competitive amusement and/or joy to a recipient, comprising:
(a) at least one card;
(b) at least one non-competitive instruction provided on the card;
wherein the instruction is hidden until revealed by the recipient; and
wherein the instruction instructs the recipient to take a non-competitive post-revealing action.

7. The system of claim 6, wherein the post-revealing action comprises a charitable contribution.

8. The system of claim 6, wherein the instruction is provided on a front surface of a card.

9. The system of claim 8, further comprising a removable coating applied to the card and adapted to at least partially obscure the instruction.

10. The system of claim 6, further comprising a removable coating applied to the card and adapted to at least partially obscure the instruction.

11. The system of claim 6, wherein the card comprises a greeting card.

12. The system of claim 6, wherein the card is at least partially enclosed in a fortune cookie.

13. The system of claim 6, wherein the card comprises an electronic representation provided over a wide area network.

14. The system of claim 13, wherein the wide area network comprises the Internet.

15. The system of claim 6, wherein the instruction is capable of being delivered to a plurality of recipients.

16. A method of providing amusement or joy, comprising the steps:
(a) obtaining a card wherein the card comprises at least one non-competitive instruction; and
(b) sending the card to a recipient;
wherein the instruction is hidden until revealed after Step (b).

17. The method of claim 16, further comprising:
(c) allowing the recipient to reveal the instruction.

18. The method of claim 17, wherein allowing the recipient to reveal the instruction comprises providing a removable coating over at least a portion of the instruction.

19. The method of claim 16, further comprising:
(d) contributing to a charity.

20. The method of claim 19, wherein contributing to a charity comprises producing an amount of a donation according to a graduated scale of charity participation.

21. The method of claim 16, wherein the card comprises an electronic representation provided over a wide area network.

22. A method of receiving joy or amusement by a recipient, comprising the steps of:
(a) receiving a card wherein the card comprises an instruction which is at least partially hidden;
(b) revealing the instruction; and
(c) receiving amusement or joy from reading the instruction.

23. The method of claim 22, wherein revealing the instruction comprises removing a coating over at least a portion of the instruction.

24. The method of claim 22, wherein revealing the instruction comprises removing a coating from a front surface of the card and reviewing the revealed instruction on the front surface.

25. The method of claim 22, further comprising:
(d) following the instruction.

26. The method of claim 22, further comprising
(d) contributing to a charity.

27. The method of claim 22, further comprising:
(d) forwarding the instruction to a third party.

28. The method of claim 22, wherein the card comprises an electronic representation provided over a wide area network.
